(19) United States
(12) Patent Application Publication
(10) Pub. No.: US 2024/0360883 A1
(43) Pub. Date: Oct. 31, 2024

(54) FRICTION MATERIAL COMPOSITION AND FRICTION MATERIAL

(71) Applicant: ADVICS CO., LTD., Kariya-shi (JP)

(72) Inventors: Osayoshi KATO, Kariya-shi (JP); Ryosuke KOZAKAI, Kariya-shi (JP)

(73) Assignee: ADVICS CO., LTD., Kariya-shi (JP)

(21) Appl. No.: 18/685,118

(22) PCT Filed: Sep. 27, 2022
(86) PCT No.: PCT/JP2022/036002

§ 371 Date: Feb. 20, 2024

(30) Foreign Application Priority Data
Sep. 27, 2021 (JP) 2021-156750

(51) Int. Cl. F16D 69/02

(52) U.S. Cl. CPC F16D 69/028; F16D 2200/003

(57) ABSTRACT

A friction material composition, which is for molding a friction material for a braking device of a vehicle provided with a regenerative brake, in which the content of copper is 5% by mass or less in terms of elemental copper based on the friction material composition, and which includes a titanate having a layered crystal structure and a lithium potassium titanate having a tunnel crystal structure.

### TECHNICAL FIELD

The present disclosure relates to a friction material composition and a friction material.

### BACKGROUND ART

In a disk brake pad and a brake shoe of a braking device such as a disk brake or a drum brake, a friction material is used.

PTL 1 discloses a friction material composition not including copper as the element or having a copper content rate of not more than 0.5% by mass, and including potassium titanate and at least one of lithium potassium titanate and magnesium potassium titanate, proviso that the total amount of potassium titanate and the at least one of lithium potassium titanate and magnesium potassium titanate is from 10 to 35% by mass and the mass reduction rate at heating the composition at 500° C. under an air atmosphere is from 5 to 20%. It is disclosed therein that the friction material prepared by molding the friction material composition is capable of forming a stable transfer film (coating film) at a light-load braking, which is typical as in a regenerative cooperation braking etc., thereby exhibiting a stable friction coefficient.

PTL 2 discloses a friction material composition, in which the copper content is 0.5% by mass or less in terms of elemental copper, and which includes a titanate having a tunnel crystal structure and a titanate having a layered crystal structure as titanates. It is disclosed therein that the friction material prepared by molding the friction material composition is excellent in wear resistance and stability of friction coefficient at a braking with a high temperature and a high speed.

### CITATION LIST

### Patent Literature

PTL 1: JP2017-2186A

PTL 2: JP2015-147913A

### BRIEF SUMMARY

### Technical Problem

With respect to a vehicle provided with a regenerative brake, wear of the braking pad is less as compared with a vehicle not provided with a regenerative brake, so that the life of the pad tends to be extended. For exhibiting the stability of wear performance and a rust preventing effect, it is necessary that a coating film derived from a friction material is stably formed on the surface of a disc rotor or a drum. Even if the coating film is formed once, the coating film disappears, for example, during the repetition from the generation of a rust at high-load braking or while the friction material is left under a certain environment to removing of the rust, and therefore, continuous formation of the coating film is required. However, with respect to a vehicle provided with a regenerative brake, the wear of the pad is less, and therefore, a new friction surface does not often appear in the case where the above-described conventional friction material is used in the vehicle provided with a regenerative brake, and therefore, it is impossible to continue to form a coating film continuously. As a result thereof, in the use of the above-described conventional friction material, it is impossible to exhibit a stable friction performance over a long period.

An embodiment of the present disclosure has an object of providing a friction material which hardly causes the change of performance over a long period in the case where it is used for a friction material for a braking device of a vehicle provided with a regenerative brake.

### Solution to Problem

The present inventors have conducted an intensive research to solve the above problems and first have found that the friction material, which includes a titanate having a layered crystal structure and a lithium potassium titanate having a tunnel crystal structure in a composition having a copper content of 5% by mass or less in terms of elemental copper, hardly causes the change of performance over a long period even in the case where it is used for a friction material for a braking device of a vehicle provided with a regenerative brake. Namely, a friction material composition according to an embodiment of the present disclosure is a friction material composition, which is for molding a friction material for a braking device of a vehicle provided with a regenerative brake, and has a constitution where the content of copper is 5% by mass or less in terms of elemental copper based on the friction material composition, and a titanate having a layered crystal structure and a lithium potassium titanate having a tunnel crystal structure are included.

### Advantageous Effects

According to an embodiment of the present disclosure, based on a composition having a content of copper, which has a high environment burden, of 5% by mass or less in terms of elemental copper, it is possible to provide a friction material which hardly causes the change of performance over a long period in the case where it is used for a friction material for a braking device of a vehicle provided with a regenerative brake.

### DESCRIPTION OF EMBODIMENTS

### 1. Friction Material Composition

The friction material composition according to an embodiment of the present disclosure is a friction material composition, which is for molding a friction material for a braking device of a vehicle provided with a regenerative brake, in which the content of copper is 5% by mass or less in terms of elemental copper based on the friction material composition, and which includes a titanate having a layered crystal structure and lithium potassium titanate having a tunnel crystal structure. The friction material composition according to the embodiment is intended to those where the friction material raw materials including the above-described components are compounded, and can be used for molding the friction materials described later.

### Characteristics

With respect to the friction material composition according to the embodiment, the content of copper is 5% by mass or less in terms of elemental copper based on the friction material composition, so the environment burden is less, and further, since a titanate having a layered crystal structure and lithium potassium titanate having a tunnel crystal structure are included, the friction material composition according to the embodiment can exhibit an effect of providing a friction material which hardly causes the change of performance over a long period regardless of the presence or the absence of the regenerative braking even in the composition where the content of copper is 5% by mass or less in terms of elemental copper.

Further, the friction material prepared by using the friction material composition according to the embodiment hardly causes the change of performance over a long period regardless of the presence or the absence of the regenerative braking, and therefore, good brake feeling can be retained over a long period as compared with the conventional friction materials.

### Application

The friction material composition according to the embodiment having the characteristics described above is particularly useful as the friction material composition for molding a friction material to be used for the friction surface of a disk brake pad or a brake shoe for a drum brake for a vehicle provided with a regenerative brake such as an electric vehicle (EV) or a hybrid electric vehicle (HEV). With respect to the vehicle provided with a regenerative brake, the friction contact occurs frequently at a liquid pressure which falls within a range of a liquid pressure not causing a braking torque such as braking at a low liquid pressure by a regenerative brake or a preceding pressurization performed before the initiation of the switching operation between the regenerative braking and the friction braking (for example, WO2020/004241). The friction material prepared by molding the friction material composition of the embodiment enables continuous formation of a coating film not depending on (regardless of) the presence or the absence of regenerative braking, and therefore, can exhibit such an excellent effect that the friction coefficient is stable over a long period and the change of performance hardly changes even when it is used as the friction material for a braking device of a vehicle provided with a regenerative brake. Namely, it can be said that the friction material of the embodiment is particularly useful as the friction material for a braking device of a vehicle provided with a regenerative brake.

The friction material prepared by molding the friction material composition of the embodiment can be particularly suitably applied as a friction material for a braking device of a vehicle provided with a regenerative brake, and however, the application is not limited to the friction material for a braking device of a vehicle provided with a regenerative brake. The friction material prepared by molding the friction material composition of the embodiment can be used suitably as the friction material which is used for the friction surface of a disk brake pad, a brake shoe of a drum brake, or the like, which is applied for the whole vehicles including a two-wheeled vehicle.

### Raw Materials

In the following, the raw materials included in the friction material composition according to the embodiment (friction material raw materials) are described below.

### Copper

With respect to the friction material composition according to the embodiment of the present disclosure, the content of copper in the friction material composition is 5% by mass or less in terms of elemental copper. With respect to the friction material composition according to the embodiment of the present disclosure, the content of copper and a copper alloy, which are high in environmental hazards, is small, and the friction material composition according to the embodiment exhibits the effect that a friction material being friendly environmentally can be provided. From the viewpoint of providing the friction material being more friendly environmentally, the content of copper in the friction material composition is preferably 0.5% by mass or less in terms of elemental copper, more preferably 0% by mass (free of copper). Copper included in the friction material composition according to the embodiment of the present disclosure may be derived from a copper fiber added as the fiber substrate.

### Titanate Having a Layered Crystal Structure and Lithium Potassium Titanate Having a Tunnel Crystal Structure

The friction material composition according to an embodiment of the present disclosure includes a titanate having a layered crystal structure and a lithium potassium titanate having a tunnel crystal structure.

The titanate having a layered crystal structure has a layered crystal structure composed of units each formed by a range of sets each formed by TiO₆ octahedrons or TiO₅ trigonal dipyramids which are connected to each other sharing part of their ridges. With respect to the layered crystal structure, an ion of at least one element selected from alkali metals excluding lithium coordinates between the layers. It is preferred that potassium ion coordinates between the layers of the layered crystal structure in view of exhibiting an excellent coating film generation effect. The part of the Ti positions for forming the layered crystal structure may be replaced by an element such as lithium or magnesium.

In terms of the coating film generation effect, the kinds of the titanate having a layered crystal structure are not particularly limited. With respect to the titanate having a layered crystal structure, one kind thereof may be used singly or plural kinds thereof may be used in combination. In view of exhibiting an excellent coating film generation effect, it is preferred that the friction material composition according to an embodiment of the present disclosure include at least one of lithium potassium titanate having a layered crystal structure and magnesium potassium titanate having a layered crystal structure as the titanate having a layered crystal structure. The molar ratios of the respective elements constituting a lithium potassium titanate having a layered crystal structure or a magnesium potassium titanate having a layered crystal structure are not limited particularly in terms of the coating film generation effect.

The lithium potassium titanate having a tunnel crystal structure has a tunnel crystal structure composed of units each formed by a range of sets each formed by TiO₆ octahedrons which are connected to each other sharing part of their ridges. The part of the Ti positions is replaced by lithium element, and potassium ion coordinates inside the tunnel of the tunnel crystal structure. The molar ratios of the respective elements constituting the lithium potassium titanate having a tunnel crystal structure are not limited particularly in terms of the coating film generation effect.

The particle sizes of the titanate having a layered crystal structure and the lithium potassium titanate having a tunnel crystal structure are not limited particularly. The titanate having a layered crystal structure or the lithium potassium titanate having a tunnel crystal structure each having an average particle of 100 μm or less is preferred since it can be mixed uniformly without deviation in the production of the friction material composition and the particles are hard to fall from the friction surface at braking. Further, from the viewpoint of the handling property in the production of the friction material composition, it is preferred that the average particle size of the titanate having a layered crystal structure or the lithium potassium titanate having a tunnel crystal structure is 1 μm or more. Here, the average particle size of the titanate having a layered crystal structure or the lithium potassium titanate having a tunnel crystal structure is the median size, in terms of volume, according to JIS Z 8825 “Particle size analysis—Laser diffraction methods”. For confirming the particle size after the formation of the friction material, from an electron microscope image of the cross section of the friction material, the average particle size of particles corresponding to the titanate having a layered crystal structure or the lithium potassium titanate having a tunnel crystal structure and the particle size distribution in terms of volume are measured according to JIS Z 8827-1: “Particle size analysis-Image analysis methods-Part 1: Static image analysis method”, and the median size is then determined.

### Action and Effect of Titanate Having a Layered Crystal Structure or the Lithium Potassium Titanate Having a Tunnel Crystal Structure

The friction material composition according to an embodiment of the present disclosure includes both the titanate having a layered crystal structure and the lithium potassium titanate having a tunnel crystal structure, and therefore, can exhibit an excellent effect that the friction coefficient is stable over a long period from the initial stage to the later stage of the car life and the change of performance is hard to be caused, regardless of the presence or the absence of the regenerative braking.

This is because, under such a condition that the friction braking peculiar to the vehicle provided with a regenerative brake is less and wear of the friction material are unlikely to proceed, the titanate having a layered crystal structure enables the coating film generation effect to be exhibited from the initial stage to the middle stage of the car life and the lithium potassium titanate having a tunnel crystal structure enables the coating film generation effect to be exhibited from the middle stage to the later stage of the car life.

The mechanism appears to be as follows. First, for the coating film generation, release of potassium to the friction surface on friction braking is important. The titanate having a layered crystal structure and the titanate having a tunnel crystal structure are different in the potassium release characteristic as described below.
Titanate having a layered crystal structure: Potassium is apt to be easily released. Potassium is likely to be released when water is included due to rain or car washing.
Titanate having a tunnel crystal structure: Potassium is unlikely to be released.

With respect to the vehicle not provided with a regenerative brake, friction braking is conducted frequently and therefore, wear of the friction material is likely to proceed, so that potassium is released continuously and a coating film is generated stably, regardless of whether the crystal structure of the titanate is a layered one or a tunnel one.

On the other hand, with respect to the vehicle provided with a regenerative brake, friction braking is not conducted frequently and therefore, wear of the friction material is unlikely to proceed, Accordingly, in the case where the crystal structure of the titanate is a tunnel one only, potassium is not released at the initial stage of the car life, and at the latter stage of the car life, potassium becomes to be released, and on the other hand, in the case where the crystal structure of the titanate is a layered one only, potassium is released at the initial stage of the car life, and however, the release of potassium is finished at the initial stage of the car life, so that, at the latter stage of the car life, potassium is not released and a coating film cannot be formed.

Since the friction material composition according to an embodiment of the present disclosure includes both the titanate having a layered crystal structure and the lithium potassium titanate having a tunnel crystal structure, it is possible to provide a friction material capable of generating a coating film stably over a long period from the initial stage of the car life to the latter stage of the car life utilizing the difference in the characteristic of releasing potassium between the titanate having a layered crystal structure and the titanate having a tunnel crystal structure. Further, the use of lithium potassium titanate having a tunnel crystal structure as the titanate having a tunnel crystal structure enables a coating film to be generated more stably than the use of the other titanate having a tunnel crystal structure in the case where a regenerative braking is conducted.

### Contents of Titanate Having a Layered Crystal Structure or Lithium Potassium Titanate Having a Tunnel Crystal Structure

The respective contents of the titanate having a layered crystal structure and the lithium potassium titanate having a tunnel crystal structure in the friction material composition are not limited particularly. The more the total content of the titanate having a layered crystal structure and the lithium potassium titanate having a tunnel crystal structure in the friction material composition is, the higher the coating film generation effect is.

In the case where the total content of the titanate having a layered crystal structure and the lithium potassium titanate having a tunnel crystal structure in the friction material composition is 10% by mass or more, the long-term stability of the friction coefficient is good sufficiently. From the viewpoint of further enhancing the long-term stability of the friction coefficient, the total content of the titanate having a layered crystal structure and the lithium potassium titanate having a tunnel crystal structure is preferably 15% by mass or more, more preferably 20% by mass or more. Incidentally, in the present description, the content of an arbitrary component in the friction material composition means proportion (% by mass) of the component when the total amount of the friction material composition is taken as 100% by mass.

From the viewpoint of exhibiting the coating film generation effect, the upper limit of the total content of the titanate having a layered crystal structure and the lithium potassium titanate having a tunnel crystal structure in the friction material composition is not limited, and however, from the viewpoint of satisfying both the long-term stability of the friction coefficient and the other performance required for the friction material simultaneously, the total content of the titanate having a layered crystal structure and the lithium potassium titanate having a tunnel crystal structure in the friction material composition is preferably 30% by mass less, more preferably 25% by mass or less.

The content of the lithium potassium titanate having a tunnel crystal structure in the friction material composition can be set appropriately as long as the total content of the titanate having a layered crystal structure and the lithium potassium titanate having a tunnel crystal structure in the friction material composition falls within the above-described range and the content of the titanate having a layered crystal structure is 2% by mass or more. From the viewpoint of the long-term stability of the friction coefficient, the lithium potassium titanate having a tunnel crystal structure in the friction material composition is preferably 2% by mass or more, as long as the total content of the titanate having a layered crystal structure and the lithium potassium titanate having a tunnel crystal structure in the friction material composition falls within the above-described range. Accordingly, for example, when the upper limit of the total content of the titanate having a layered crystal structure and the lithium potassium titanate having a tunnel crystal structure in the friction material composition is 30% by mass, the content of the lithium potassium titanate having a tunnel crystal structure in the friction material composition can be set appropriately within the range of 2% by mass or more and 28% by mass or less.

### Titanate Other than the Titanate Having a Layered Crystal Structure and the Lithium Potassium Titanate Having a Tunnel Crystal Structure

An embodiment of the friction material composition according to the present disclosure may include a titanate known in the technical field besides the titanate having a layered crystal structure and the lithium potassium titanate having a tunnel crystal structure as long as the effects of the present disclosure are not impaired.

### Other Components

The friction material composition according to the embodiment includes a fiber substrate, a binder, an organic filler and an inorganic filler other than a titanate, besides the above-described components, as the friction material raw materials.

### Fiber Substrate

As the fiber substrate, examples thereof include an organic fiber, an inorganic fiber, and a metal fiber. Such a fiber may be a natural fiber or a synthetic fiber synthesized artificially. Examples of the organic fiber include an aromatic polyamide fiber (aramid fiber), an acrylic fiber, a cellulose fiber, and a carbon fiber. Examples of the inorganic fiber include a rock wool, and a glass fiber. Examples of the metal fiber include a fiber composed of the sole metal of steel, stainless steel, aluminum, zinc, or tin, and a fiber composed of the alloy metal with respect to each of these metals. With respect to the fiber substrate, one kind thereof may be used singly or plural kinds thereof may be used in combination. The content of the fiber substrate in the friction material composition is not limited particularly, and may be those being applied generally in the technical field.

### Binder

The binder has the function of binding the friction material raw materials in the friction material composition. The binder is not limited particularly as long as it exhibits the above-described performance, and the binders known in the technical field can be preferably used. Examples of the binder include resins such as a phenol resin, an epoxy resin, a melamine resin, and an imide resin. With respect to the binder, one kind thereof may be used singly or plural kinds thereof may be used in combination. The content of the binder in the friction material composition is not limited particularly, and can be set to the content being ordinarily adopted in the technical field.

### Organic Filler

The organic filler functions as a friction-adjusting material for enhancing the wear resistance and the like. The organic filler is not limited particularly as long as it can exhibit the above-described performance. The organic fillers known in the technical field can be preferably used. Examples of the organic filler include cashew dust, rubber powder, tire powder, a fluorine resin, melamine cyanurate, and a polyethylene resin. With respect to the organic filler, one kind thereof may be used singly or plural kinds thereof may be used in combination. The organic filler may be an organic filler, the surface of which is coated with phosphoric acid or a fluorine resin. The content of the organic filler in the friction material composition is not limited particularly, and can be set to the content being ordinarily adopted in the technical field.

### Inorganic Filler other than Titanate

The friction material composition according to the embodiment may include an inorganic filler other than titanate as long as the effect of the present disclosure is not impaired. As the inorganic filler other than titanate, inorganic substances known in the technical field can be preferably used. Examples thereof include zirconium oxide, barium sulfate, mica, an iron oxide (ferrous oxide, ferric oxide, etc.), calcium hydroxide, and calcium carbonate. With respect to the inorganic filler, one kind thereof may be used singly or plural kinds thereof may be used in combination. The content of the inorganic filler other than the titanate is not limited particularly, and can be set to the content being ordinarily adopted in the technical field. Further, the particle size of the inorganic filler other than the titanate is not limited particularly, and the inorganic substance having the average particle size being ordinarily adopted in the technical field can be preferably used.

### Lubricant

The friction material composition according to the embodiment may further include a lubricant as long as the effects of the present disclosure are not impaired. The lubricant is not limited particularly, and lubricants known in the technical field can be preferably used. Examples of the lubricant include coke, black lead, carbon black, graphite, and metal sulfide. Examples of the metal sulfide include tin sulfide, antimony trisulfide, molybdenum disulfide, bismuth sulfide, iron sulfide, zinc sulfide, and tungsten sulfide. With respect to the lubricant, one kind thereof may be used singly or plural kinds thereof may be used in combination. The content of the lubricant is not limited particularly, and can be set to the content being ordinarily adopted in the technical field.

### Production Method of Friction Material Composition

The friction material composition according to the embodiment can be produced by a production method which includes a mixing step including compounding the above-described friction material raw materials, and mixing them. From the viewpoint of mixing the friction material raw materials uniformly, the mixing step is preferably a step of mixing powder-like friction material raw materials. The mixing method and the mixing conditions for the mixing step are not limited particularly as long as the friction material raw materials can be mixed uniformly, and methods known in the technical field can be adopted. For example, the friction material raw materials can be mixed for about 10 minutes at ordinary temperature using a known mixer such as a HENSCHEL mixer or a LÖDIGE mixer. In the mixing step, the mixing may be performed while the mixture of the friction material raw materials is cooled according to a known cooling method such that the temperature of the friction material raw materials during mixing is not increased.

### 2. Friction Material

The friction material according to the embodiment of the present disclosure is one prepared by molding the above-described friction material composition according to the embodiment of the present disclosure. The effects and application of the friction material of the embodiment are as described in the description on the friction material composition of the present disclosure, and therefore, no repetition is described here.

### Production Method of Friction Material

The friction material according to the embodiment can be produced according to a production method which includes a molding step of molding the friction material composition according to the embodiment of the present disclosure. The molding method and the molding conditions in the molding step are not limited particularly as long as one embodiment of the friction material composition of the present disclosure can be molded into a predetermined shape, and methods known in the technical field can be adopted. For example, one embodiment of the friction material composition of the present disclosure can be molded by pressing and compacting it with a press etc. As the molding method with a press, a hot press method in which molding is performed by pressing and compacting the friction material composition of the present disclosure while heating, and an ordinary-temperature press method in which molding is performed by pressing and compacting the friction material composition of the present disclosure at an ordinary temperature without heating, each can be preferably adopted. In the case of molding by the hot press method, the friction material composition of the present disclosure can be molded into the friction material, for example, by setting the molding temperature to 140° C. or more and 200° C. or less (preferably 160° C.), the molding pressure to 10 MPa or more and 40 MPa or less (preferably 20 MPa), and the molding time to 3 minutes or more and 15 minutes or less (preferably 10 minutes). In the case of molding by the ordinary-temperature press method, the friction material composition of the present disclosure can be molded into the friction material, for example, by setting the molding pressure to 50 MPa or more and 200 MPa or less (preferably 100 MPa), and the molding time to 5 seconds or more and 60 seconds or less (preferably 15 seconds). Further, a polishing step of polishing the surface of the friction material to form the friction surface may be performed, if necessary.

### 3. Friction Member

A friction member having the friction material according to the embodiment of the present disclosure as a friction surface falls within the scope of the present disclosure. As the friction member, a constitution where only the friction material of the present disclosure is provided, or a constitution where a plate-like member, such as a metal plate, as a back plate and the friction material of the present disclosure are integrated may be adopted. The effects and application of the friction member of the embodiment are as described in the description on the friction material composition according to the present disclosure, and therefore, no repetition is described here.

In the case where the friction member according to the embodiment has a constitution where a plate-like member and the friction material of the present disclosure are integrated, the friction material of the present disclosure and the plate-like member are subjected to a clamp processing, and then a heat treatment, thereby enabling the adhesion between the friction material of the present disclosure and the plate-like member. The conditions for the clamp processing are not limited particularly, and are, for example, 180° C., 1 MPa, and for 10 minutes. Further, the conditions for the heat treatment after the clamp processing are not limited particularly, and are, for example, 150° C. or more and 250° C. or less for 5 minutes or more and 180 minutes or less, preferably 230° C. for 3 hours.

### SUMMARY

The friction material composition according to Embodiment 1 of the present disclosure is a friction material composition, which is for molding a friction material for a braking device of a vehicle provided with a regenerative brake, and has a constitution where the content of copper is 5% by mass or less in terms of elemental copper based on the friction material composition and the friction material composition includes a titanate having a layered crystal structure and a lithium potassium titanate having a tunnel crystal structure.

As the friction material composition according to Embodiment 2 of the present disclosure, a constitution where the total content of the titanate having a layered crystal structure and the lithium potassium titanate having a tunnel crystal structure in the friction material composition is 10% by mass or more and 30% by mass or less in Embodiment 1 described above is preferred.

As the friction material composition according to Embodiment 3 of the present disclosure, a constitution where the total content of the titanate having a layered crystal structure and the lithium potassium titanate having a tunnel crystal structure in the friction material composition is 10% by mass or more and 25% by mass or less in Embodiment 2 described above is more preferred.

As the friction material composition according to Embodiment 4 of the present disclosure, a constitution where the content of the lithium potassium titanate having a tunnel crystal structure in the friction material composition is 2% by mass or more in Embodiment 2 or 3 described above is more preferred.

As the friction material composition according to Embodiment 5 of the present disclosure, a constitution where the titanate having a layered crystal structure is one where a potassium ion coordinates between layers of the titanate having a layered crystal structure in any one of Embodiments 1 to 4 described above is preferred.

As the friction material composition according to Embodiment 6 of the present disclosure, a constitution where at least one of lithium potassium titanate having a layered crystal structure and magnesium potassium titanate having a layered crystal structure is included as the titanate having a layered crystal structure in any one of Embodiments 1 to 5 described above is preferred.

The friction material according to Embodiment 7 of the present disclosure has a constitution where the friction material is a friction material for a braking device of a vehicle provided with a regenerative brake and is prepared by molding the friction material composition according to any one of Embodiments 1 to 6 described above.

The present disclosure is not limited to the respective embodiments described above, various modifications can be performed within the scopes described in the claims, and embodiments constituted by appropriately combining the respective technical means disclosed in the different embodiments also fall within the technical scope of the present disclosure.

### EXAMPLES

### Friction Material Raw Materials

The friction material raw materials used in Examples and Comparative Examples are as follows.
Lithium potassium titanate having a layered crystal structure: compositional formula K_{0.5-0.7}Li_{0.27}Ti_{1.73}O_{3.85-3.95}
Magnesium potassium titanate having a layered crystal structure: compositional formula K_{0.2-0.7}Mg_{0.4}Ti_{1.6}O_{3.7-3.95}
Lithium potassium titanate having a tunnel crystal structure: compositional formula K_{2.10}Ti_{5.90}Li_{0.10}O_{12.9}
Potassium titanate having a tunnel crystal structure: compositional formula K₂Ti₆O₁₃

With respect to the raw materials other than the above-described friction raw materials which are indicated in Table 1, those being used ordinarily in the technical field were used.

### Example 1

### Preparation of Brake Pad

The respective raw materials were compounded according to the compounding rate as indicated in Table 1, and mixed for about 10 minutes at ordinary temperature (20° C.) in a LÖDIGE mixer, thereby obtaining a friction material composition. Incidentally, the unit of the compounded amount of each raw material in Table 1 is % by mass in the friction material composition.

Each molded article was obtained by pressing and compacting the friction material composition during heating by means of a molding press according to a hot press construction method. The molding conditions in the hot press construction method are as follows.
Molding temperature: 160° C.
Molding pressure: 20 MPa
Molding time: 10 minutes

The surface of the obtained molded article was polished with a polisher to form a friction surface, thereby obtaining a friction material. A brake pad of Example 1 was prepared by using the friction material, and then subjected to a friction coefficient stability test. The thickness and the projected area of the friction material of the brake pad prepared in Example 1 are 12.5 mm and 55 cm², respectively.

### Examples 2 to 11

Brake pads of Examples 2 to 11 each was prepared in the same manner as in Example 1 except that the respective raw materials were compounded according to the compounding rate indicated in Table 1.

### Comparative Examples 1 to 7

Brake pads of Comparative Examples 1 to 7 each was prepared in the same manner as in Example 1 except that the respective raw materials were compounded according to the compounding rate indicated in Table 1.

### Friction Coefficient Stability Test

Watering and braking were repeated and then, stability of the friction coefficient was evaluated. Concretely, water is poured onto the surface of a disc brake and allowed to stand for 2 hours, and then braking at a rate of 1 m/s² for a car having a speed of 40 km/h, was repeated 400 times, and this was taken as 1 cycle.

After the 7th cycle was performed, the difference between the average friction coefficient based on all the results of the 1st cycle and the average friction coefficient based on all the results of the 7th cycle was calculated and the stability of the friction coefficient was evaluated in terms of four steps A to D according to the following criteria.
A (excellent): The difference between the average friction coefficient based on all the results of the 1st cycle and the average friction coefficient based on all the results of the 7th cycle is 0 or more and less than 0.01.
B (good): The difference between the average friction coefficient based on all the results of the 1st cycle and the average friction coefficient based on all the results of the 7th cycle is 0.01 or more and less than 0.02.
C (slightly inappropriate): The difference between the average friction coefficient based on all the results of the 1st cycle and the average friction coefficient based on all the results of the 7th cycle is 0.02 or more and less than 0.03.
D (inappropriate): The difference between the average friction coefficient based on all the results of the 1st cycle and the average friction coefficient based on all the results of the 7th cycle is 0.03 or more.

Incidentally, in order to confirm the difference in effect between the presence and the absence of regenerative braking, with respect to the above test, evaluation was performed in both the presence and the absence of regenerative braking.

### Results

The respective evaluation results of the stability test of the friction coefficient are shown in Table 1.

TABLE 1

| | Exam- | Exam- | Exam- | Exam- | Exam- | Exam- | Exam- | Exam- | Exam- | Exam- | Exam- |
|---|---|---|---|---|---|---|---|---|---|---|---|
| [% by mass] | ple 1 | ple 2 | ple 3 | ple 4 | ple 5 | ple 6 | ple 7 | ple 8 | ple 9 | ple 10 | ple 11 |
| Copper Fiber | 0 | 0 | 0 | 0 | 0 | 0 | 0 | 0 | 0 | 0 | 0 |
| Iron Fiber | 1.5 | 1.5 | 1.5 | 1.5 | 1.5 | 1.5 | 1.5 | 1.5 | 1.5 | 1.5 | 1.5 |
| Cashew Dust | 2 | 2 | 2 | 2 | 2 | 2 | 2 | 2 | 2 | 2 | 2 |
| Black Lead | 4 | 4 | 4 | 4 | 4 | 4 | 4 | 4 | 4 | 4 | 4 |
| Aramid Fiber | 5 | 5 | 5 | 5 | 5 | 5 | 5 | 5 | 5 | 5 | 5 |
| Inorganic Fiber | 0.5 | 0.5 | 0.5 | 0.5 | 0.5 | 0.5 | 0.5 | 0.5 | 0.5 | 0.5 | 0.5 |
| Mica | 10 | 10 | 10 | 10 | 10 | 10 | 10 | 10 | 10 | 10 | 10 |
| Zirconium Oxide | 0.5 | 0.5 | 0.5 | 0.5 | 0.5 | 0.5 | 0.5 | 0.5 | 0.5 | 0.5 | 0.5 |
| Iron Oxide | 4 | 4 | 4 | 4 | 4 | 4 | 4 | 4 | 4 | 4 | 4 |
| Fluorine Polymer | 1 | 1 | 1 | 1 | 1 | 1 | 1 | 1 | 1 | 1 | 1 |
| Rubber Powder | 1 | 1 | 1 | 1 | 1 | 1 | 1 | 1 | 1 | 1 | 1 |
| Phenol Resin | 9 | 9 | 9 | 9 | 9 | 9 | 9 | 9 | 9 | 9 | 9 |
| Calcium Carbonate | 3 | 3 | 3 | 3 | 3 | 3 | 3 | 3 | 3 | 3 | 3 |
| Calcium Hydroxide | 4 | 4 | 4 | 4 | 4 | 4 | 4 | 4 | 4 | 4 | 4 |
| Metal Sulfide | 1 | 1 | 1 | 1 | 1 | 1 | 1 | 1 | 1 | 1 | 1 |
| Barium Sulfide | 28.5 | 28.5 | 28.5 | 28.5 | 33.5 | 33.5 | 38.5 | 38.5 | 43.5 | 43.5 | 43.5 |
| Lithium Potassium Titanate | 20 | 5 | | | 15 | 5 | | | 8 | | 2 |
| Layered Crystal Structure | | | | | | | | | | | |
| Magnesium Potassium Titanate | | | 5 | 20 | | | 10 | 5 | | 5 | |
| Layered Crystal Structure | | | | | | | | | | | |
| Lithium Potassium Titanate | 5 | 20 | 20 | 5 | 5 | 15 | 5 | 10 | 2 | 5 | 8 |
| Tunnel Crystal Structure | | | | | | | | | | | |
| Potassium Titanate | | | | | | | | | | | |
| Tunnel Crystal Structure | | | | | | | | | | | |
| Stability of Friction | A | A | A | A | A | A | A | A | B | B | B |
| Coefficient at Watering Repeated | | | | | | | | | | | |
| (With Regenerative Braking) | | | | | | | | | | | |
| Stability of Friction | A | A | A | A | A | A | B | B | B | B | B |
| Coefficient at Watering Repeated | | | | | | | | | | | |
| (Without Regenerative Braking) | | | | | | | | | | | |

| | Comparative | Comparative | Comparative | Comparative | Comparative | Comparative | Comparative |
|---|---|---|---|---|---|---|---|
| [% by mass] | Example 1 | Example 2 | Example 3 | Example 4 | Example 5 | Example 6 | Example 7 |
| Copper Fiber | 0 | 0 | 0 | 0 | 0 | 0 | 0 |
| Iron Fiber | 1.5 | 1.5 | 1.5 | 1.5 | 1.5 | 1.5 | 1.5 |
| Cashew Dust | 2 | 2 | 2 | 2 | 2 | 2 | 2 |
| Black Lead | 4 | 4 | 4 | 4 | 4 | 4 | 4 |
| Aramid Fiber | 5 | 5 | 5 | 5 | 5 | 5 | 5 |
| Inorganic Fiber | 0.5 | 0.5 | 0.5 | 0.5 | 0.5 | 0.5 | 0.5 |
| Mica | 10 | 10 | 10 | 10 | 10 | 10 | 10 |
| Zirconium Oxide | 0.5 | 0.5 | 0.5 | 0.5 | 0.5 | 0.5 | 0.5 |
| Iron Oxide | 4 | 4 | 4 | 4 | 4 | 4 | 4 |
| Fluorine Polymer | 1 | 1 | 1 | 1 | 1 | 1 | 1 |
| Rubber Powder | 1 | 1 | 1 | 1 | 1 | 1 | 1 |
| Phenol Resin | 9 | 9 | 9 | 9 | 9 | 9 | 9 |
| Calcium Carbonate | 3 | 3 | 3 | 3 | 3 | 3 | 3 |
| Calcium Hydroxide | 4 | 4 | 4 | 4 | 4 | 4 | 4 |
| Metal Sulfide | 1 | 1 | 1 | 1 | 1 | 1 | 1 |
| Barium Sulfide | 28.5 | 28.5 | 28.5 | 28.5 | 28.5 | 38.5 | 43.5 |
| Lithium Potassium Titanate | 20 | 25 | | | | | |
| Layered Crystal Structure | | | | | | | |
| Magnesium Potassium Titanate | | | 25 | | | | 10 |
| Layered Crystal Structure | | | | | | | |
| Lithium Potassium Titanate | | | | 25 | | 15 | |
| Tunnel Crystal Structure | | | | | | | |
| Potassium Titanate | 5 | | | | 25 | | |
| Tunnel Crystal Structure | | | | | | | |
| Stability of Friction | A | A | A | B | B | B | B |
| Coefficient at Watering Repeated | | | | | | | |
| (With Regenerative Braking) | | | | | | | |
| Stability of Friction | C | D | D | D | D | D | D |
| Coefficient at Watering Repeated | | | | | | | |
| (Without Regenerative Braking) | | | | | | | |

As shown in Table 1, the friction materials of Examples 1 to 11, in which both the lithium potassium titanate having a tunnel crystal structure and either the lithium potassium titanate having a layered crystal structure or the magnesium potassium titanate having a layered crystal structure are included, exhibited a stable friction coefficient over a long period (the 1st cycle to the 7th cycle) regardless of the presence or the absence of the regenerative braking. Further, it was shown that the friction materials of Examples 1 to 11 are excellent in the long-term stability of the friction coefficient in the case where the regenerative braking is performed as compared with the friction materials of Comparative Examples 1 to 3, 5 and 7 not including the lithium potassium titanate having a tunnel crystal structure and the friction materials of Comparative Examples 2 to 7 including only one of either of the titanate having a layered crystal structure and the titanate having a tunnel crystal structure as the titanate.

### INDUSTRIAL APPLICABILITY

The friction material composition and the friction material according to an embodiment of the present disclosure can be utilized suitably for a braking device of a vehicle such as a car, particularly the friction member mounted in the braking device of a vehicle provided with a regenerative brake.

1. A friction material composition, which is for molding a friction material for a braking device of a vehicle provided with a regenerative brake, wherein
a content of copper is 5% by mass or less in terms of elemental copper based on the friction material composition, and
the friction material composition comprises a titanate having a layered crystal structure and a lithium potassium titanate having a tunnel crystal structure.

2. The friction material composition according to claim 1, wherein the total content of the titanate having a layered crystal structure and the lithium potassium titanate having a tunnel crystal structure in the friction material composition is 10% by mass or more and 30% by mass or less.

3. The friction material composition according to claim 2, wherein the total content of the titanate having a layered crystal structure and the lithium potassium titanate having a tunnel crystal structure in the friction material composition is 10% by mass or more and 25% by mass or less.

4. The friction material composition according to claim 2, wherein a content of the lithium potassium titanate having a tunnel crystal structure in the friction material composition is 2% by mass or more.

5. The friction material composition according to claim 1, wherein, in the titanate having a layered crystal structure, a potassium ion coordinates between layers of the layered crystal structure.

6. The friction material composition according to claim 1, comprising at least one of lithium potassium titanate having a layered crystal structure and magnesium potassium titanate having a layered crystal structure as the titanate having a layered crystal structure.

7. A friction material for a braking device of a vehicle provided with a regenerative brake, which is prepared by molding the friction material composition according to claim 1.

8. The friction material composition according to claim 3, wherein a content of the lithium potassium titanate having a tunnel crystal structure in the friction material composition is 2% by mass or more.

9. The friction material composition according to claim 2, wherein, in the titanate having a layered crystal structure, a potassium ion coordinates between layers of the layered crystal structure.

10. The friction material composition according to claim 3, wherein, in the titanate having a layered crystal structure, a potassium ion coordinates between layers of the layered crystal structure.

11. The friction material composition according to claim 4, wherein, in the titanate having a layered crystal structure, a potassium ion coordinates between layers of the layered crystal structure.

12. The friction material composition according to claim 2, comprising at least one of lithium potassium titanate having a layered crystal structure and magnesium potassium titanate having a layered crystal structure as the titanate having a layered crystal structure.

13. The friction material composition according to claim 3, comprising at least one of lithium potassium titanate having a layered crystal structure and magnesium potassium titanate having a layered crystal structure as the titanate having a layered crystal structure.

14. The friction material composition according to claim 4, comprising at least one of lithium potassium titanate having a layered crystal structure and magnesium potassium titanate having a layered crystal structure as the titanate having a layered crystal structure.

15. A friction material for a braking device of a vehicle provided with a regenerative brake, which is prepared by molding the friction material composition according to claim 2.

16. A friction material for a braking device of a vehicle provided with a regenerative brake, which is prepared by molding the friction material composition according to claim 3.

17. A friction material for a braking device of a vehicle provided with a regenerative brake, which is prepared by molding the friction material composition according to claim 4.
